(19) United States
(12) Patent Application Publication
(10) Pub. No.: US 2025/0236967 A1
(43) Pub. Date: Jul. 24, 2025

(54) LOW IMPEDANCE ELECTRICAL CONNECTIONS FOR ELECTROCHEMICAL CELLS

(71) Applicant: ELECTRIC HYDROGEN CO., Natick, MA (US)

(72) Inventors: Tenzin NANCHUNG, Somerville, MA (US); David EAGLESHAM, Lexington, MA (US); Nemanja DANILOVIC, El Sobrante, CA (US); Jigish TRIVEDI, Pleasanton, CA (US)

(21) Appl. No.: 18/703,618

(22) PCT Filed: Dec. 21, 2022
(86) PCT No.: PCT/US2022/053644

§ 371 Date: Apr. 22, 2024

Related U.S. Application Data
(60) Provisional application No. 63/294,492, filed on Dec. 29, 2021.

(51) Int. Cl. C25B 9/65; C25B 1/04; C25B 9/23

(52) U.S. Cl. CPC C25B 9/65; C25B 1/04; C25B 9/23

(57) ABSTRACT

A membrane in an electrochemical cell may be electrically and/or mechanically coupled to a flow-field plate using a conductive adhesive. Various types of adhesives with conductive particles may be used. The adhesive may be selected such that in the fluid phase it is able to diffuse through one or more porous layers of the electrochemical cell, such as a liquid/gas diffusion layer. In some cases, the use of conductive adhesive may increase the level of inter-component electrical contact that may be achieved for a given level of compressive force applied between the components in the electrochemical cell.

### PRIORITY

The application claims priority to U.S. Provisional Application No. 63/294,492, filed Dec. 29, 2021, bearing Attorney Docket No. 10378-21023A, and titled LOW IMPEDANCE ELECTRICAL CONNECTIONS FOR ELECTROCHEMICAL CELLS, which is incorporated by reference herein in its entirety.

### FIELD

The following disclosure relates to low impedance electrical connections for electrochemical cells.

### BACKGROUND

Electrolyzer systems use electrical energy to drive a chemical reaction. For example, water is split to form hydrogen and oxygen. The products may be used as chemical feedstocks and/or energy sources. In recent years, improvements in operational efficiency have made electrolyzer systems competitive market solutions for energy storage, generation, and/or transport. For example, the cost of generation may be below $10 per kilogram of hydrogen in some cases. Decreases in cost, increases in efficiency, and/or improvements in operation will continue to drive installation of electrolyzer systems.

### BRIEF DESCRIPTION OF THE DRAWINGS

Example implementations are described herein with reference to the following drawings.

FIG. 1 shows an example electrochemical cell.

FIG. 2 shows an example method for creating electrical contact between a membrane and a flow-field plate.

FIG. 3 shows an example mask.

FIG. 4 shows an example flow-field plate with conductive adhesive selectively applied.

FIG. 5 shows an example electrochemical cell.

FIG. 6 shows an example electrochemical cell with example points for application of conductive adhesive.

### DETAILED DESCRIPTION

The discussed architectures and techniques may support the implementation of inter-component electrical contacts in various products. In some cases, the various discussed architectures and techniques may be implemented for membranes and/or electrodes in electrochemical cells including those used in proton exchange membrane water electrolysis (PEMWE).

In some cases, it may be desirable to electrically couple a membrane (e.g., a surface thereof) to electrodes of a flow-field plate. According to the conventional wisdom electrical contact is achieved using compressive force, which may be applied via fasteners such as screws. Further, according to the conventional wisdom the level of electrical contact scales with the level of compressive forced because deformation of the various parts against one another mediates the electrical contact.

Moreover, the conventional wisdom discourages using forms of contact other than compressive force because selective contact with electrode portions of a component and not with other portions of the component may be achieved using raised electrodes. Thus, as understood by the conventional wisdom, compressive force can achieve a level of spatial resolution with regard to electrical contact that cannot be achieved via other techniques for electrically coupling disparate components within an electrochemical cell.

Moreover, the conventional wisdom discourages using forms of contact other than compressive force because compressive force has a high level of electrochemical stability. The sometimes extreme conditions of electrochemical processing may cause various other contact means to degrade.

In some cases, the compressive force used to achieve sufficient electrical contact between the membrane and/or flow-field plate leads to damage to the membrane and/or other cell components leading to decreased manufacture yield. Thus, according to the conventional wisdom it is important dedicate significant design effort to balancing compressive force, electrical contact level, and manufacture yield.

As recognized herein and contrary to the conventional wisdom, electrical contact level may be decoupled from compressive force used via the techniques and architectures discussed herein. The various ones of the techniques and architectures discussed herein use electrical contacts with the electrochemical cells facilitated (at least in part) via conductive adhesives. The conductive adhesives reduce dependence on compressive force to create electrical contacts.

In various implementations, the electrochemical cells may be assembled using conductive adhesives with or without parallel use of fasteners such as screws. Regardless of the usage of fasteners, the electrical contact level achieved for a given level of compressive force between components may be increased for cells incorporating conductive adhesives relative to cells relying on compressive force alone. Further, by selecting the type of conductive adhesive (e.g., including the type and concentration of conductive particles within the adhesive) and the area of contact created with the adhesive, the level of electrical contact may be controlled (e.g., reduced and/or increased) without change to the level of compressive force.

Various types of adhesives may be used such as, epoxies, butyl rubber, other rubbers, cross-linkable polymers, or other adhesives. The adhesive may be permeated with one or more type of conductive particles including noble metal particles, graphite/graphene particles, or other particles of conductive material. The adhesive may be selected for stability in electrolysis conditions over time scales corresponding to device operation (e.g., the particles may be stable over the time scale of one or more device operation cycles). In some cases, stability over multiple cycles may be desirable where the particular component or assembly is impractical to replace cycle to cycle. Similarly, the conductive material within the adhesive may be selected for selected for stability in electrolysis conditions over time scales corresponding to device operation.

In various implementations, multiple different conductive adhesives may be used within a given cell or other assembly. For example, the conductive adhesives used for the cathode and/or anode contacts may differ from one another. The difference may be in the conductive particle permeating the adhesive and/or in the adhesive itself. In some cases, conductive adhesive may be used for one side (e.g., a cathode or anode side) of the membrane, but not necessarily used for the other side. For example, compressive contact may be used for one side while adhesive contact may be used for the other within a single electrochemical cell.

In some cases, the adhesive may be selected such that the fluid phase of the adhesive (e.g., before hardening) allows for diffusion through one or more porous layers of the electrochemical cell, such as a liquid/gas diffusion layer.

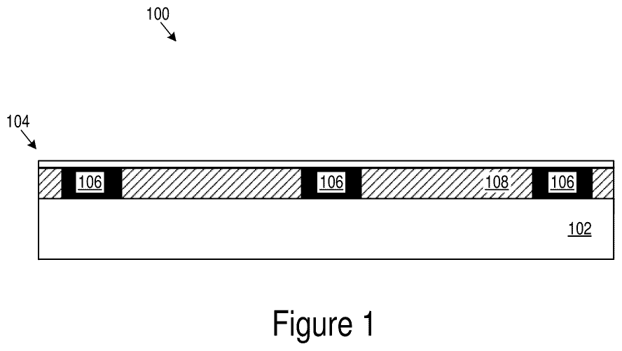

FIG. 1 shows an example electrochemical cell 100. In the example electrochemical cell 100, a flow-field plate 102 is coupled to the surface of a membrane 104. Electrical contact between the flow-field plate may be implemented via conductive adhesive 106 placed between the flow-field plate 102 and membrane 104. In various implementations, the conductive adhesive 106 may be diffused (or otherwise span across) one or more diffusion layers 108 between the membrane 104 and the flow-field plate 102. In various implementations (not shown), a pair of flow-field plates may be attached (e.g., one to either side) to the membrane 104.

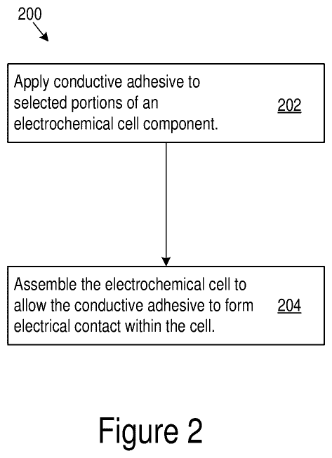

Referring now to FIG. 2 while continuing to refer to FIG. 1, FIG. 2 shows an example method 200 for creating electrical contact between a membrane and a flow-field plate.

Conductive adhesive is applied to selected portions of the flow-field plate, diffusion layer, membrane, and/or other selected components of the cell (202). In various implementations, portions for selective application of conductive adhesive may be physically distinguished from other portions of a component. For example, conductive adhesive 106 may applied to electrode contacts of the flow-field plate 102. The electrode contacts themselves may be raised relative to and/or otherwise physically separated from other portions of the flow-field plate 102, e.g., at least in part to allow for the selective application.

In some implementations a mask may be used to control the selective application of the conductive adhesive 106. For example, a mask may be placed on a face of the flow-field plate 102 before application of the conductive adhesive 106. The conductive adhesive 106 may applied and the mask may be removed. The resultant deployment of the conductive adhesive 106 may be targeted to the portions exposed when the mask is in place. For example, the mask may expose the faces of the electrode contacts of the flow-field plate 102. In the example, using the mask the electrode contacts may be exclusively targeted for application of conductive adhesive, e.g., even where the contacts lack the physical separation that may be used for selective application of the conductive adhesive 106 in other implementations. In some cases, physical separations such as raised contacts may allow for creation of electrical contact and/or other contact via compressive force during assembly. Thus, physical separation of components may be present in an implementation whether or not a mask is used to allow of selective application of conductive adhesive.

The cell components are then assembled to allow the adhesive to form a bond (and electrical contact) with the membrane (204). Because the conductive adhesive is conductive, its application may result in the selected portions where it is applied acting as electrical contacts between components. Thus, the selected portions may serve as electrical contacts between the membrane, diffusion layer(s), and/or flow-field plate. In some cases, because the conductive adhesive may diffuse through the diffusion layer(s) 108, the conductive adhesive may create an electrical contact that penetrates through these layers similar to a via in a multi-layer integrated chip.

In various implementations, the conductive adhesive 106, once cured, may provide various levels of physical coupling between components.

For example, the conductive adhesive 106 may provide flexible coupling between components. For example, flexible coupling may include coupling where components may move relative to one another (e.g., across deflection scales on the order of the component thickness) without degrading the bond created by the conductive adhesive. In some cases, flexible coupling may be associated with lower bonding strengths than semi-rigid or rigid coupling.

For example, the conductive adhesive 106 may provide semi-rigid coupling between components. For example, semi-rigid coupling may include coupling where components may move relative to one another (e.g., across deflection scales smaller than the component thickness) potentially with some degradation the bond created by the conductive adhesive. In some cases, semi-rigid coupling may be associated with bonding strengths between those of flexible and rigid coupling.

For example, the conductive adhesive 106 may provide rigid coupling between components. For example, rigid coupling may include coupling where components are contained with regard to movement relative to one other. In some cases, rigid coupling may be associated with stronger bonding strengths than flexible or semi-rigid coupling.

In various implementations, multiple different conductive adhesive may be used on different components and/or different portions of a component to provide different levels of physical coupling and/or electrical contact between bonded components.

In some implementations, a fastener, such as a screw, rivet, clamp, and/or other fastener may be used to hold the joined components in conjunction with the conductive adhesive 106. For example, the fastener may be used provide a desired level of compressive force. In an example, the fastener may be used provide a selected level of physical coupling (e.g., a level of rigidity greater than that of the conductive adhesive) while the conductive adhesive provides a selected level of electrical contact, which may be independent of the level of physical coupling and/or compressive force provided by the fastener.

### Example Implementations

Various illustrative example implementations are discussed below. The illustrative example implementations are illustrative of the general architectures and techniques described above and in the claims below. Designations of particular features such as “key”, “critical”, “important”, “must”, and/or other similar designations are included to clarify the relationship of that particular feature to the specific illustrative scenario/scenarios in which the particular feature is discussed. Such a relationship to the same degree may not apply without express description of such a relationship to other implementations. Nevertheless, such features described with respect to the individual example implementations may be readily integrated with other implementations with or without various other features present in the respective example implementation.

High resistance membranes may be connected to the various interfacial components such as the bipolar flow-field, porous transport layers, and gas diffusion layers. This electrical connection may be deployed by using conductive adhesives which allow for high interfacial surface contact and electron pathways.

In various implementations, PEMWEs components are aligned, stacked and then fastened to create a compressive force. This force allows contact to the various parts and creates electron pathways. In some cases, high compression forces can cause increased shorting and membrane thinning. In some cases lowering cell compression force may reduce the electrical contact points between components causing increased impedance.

To allow for conductivity, the adhesive may have a fluid phase to allow for diffusion through one more porous layers that may be included between flow-field plates and membranes. In some cases, the conductive adhesive may be selected for stability in PEMWE environments on both anode and cathode sides. This may include aggressive in PEMWE environments in some implementations.

Conducting adhesives may be used to increase surface contact between components and also provide a more mechanically stable stack.

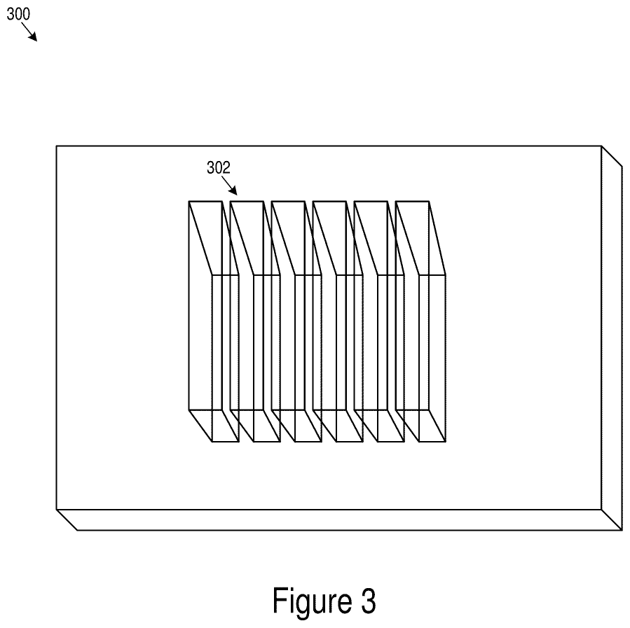

FIG. 3 shows an example mask 300 to facilitate application of conductive adhesive to specific device regions. The mask may allow for the application of conductive adhesive to select regions of the electrochemical cell. In an illustrative example, conductive adhesive may be applied to the contact faces of a flow-field plate through the openings 302 in the mask.

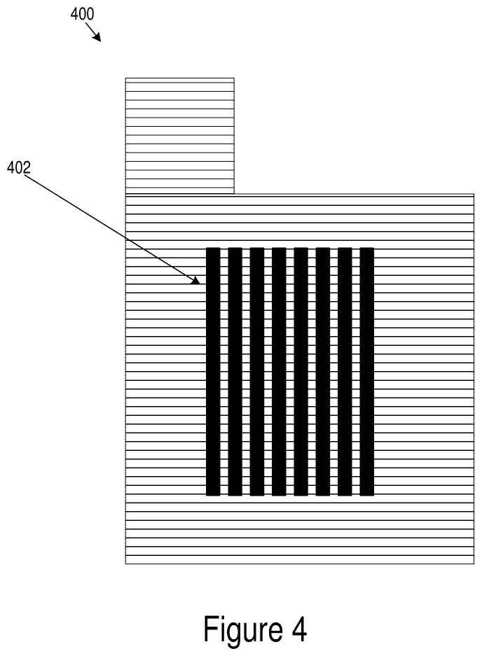

FIG. 4 shows an example flow-field plate 400 with conductive adhesive 402 applied to the electrode contact faces of the flow-field plate.

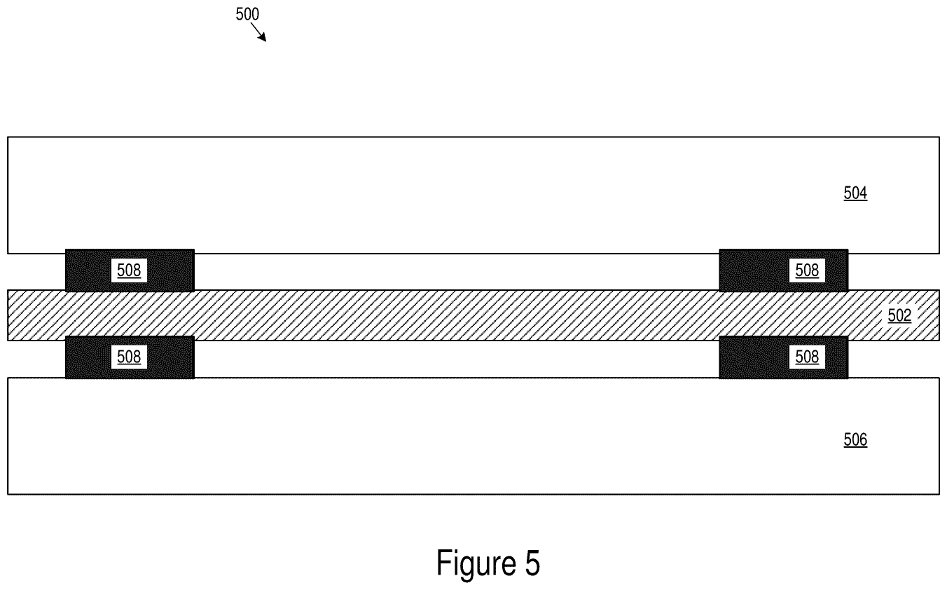

FIG. 5 shows an example electrochemical cell 500. In the example electrochemical cell 500, each side of a membrane 502 is coupled to respective bipolar plate 504, 506 of the electrochemical cell 500 via conductive adhesive 508.

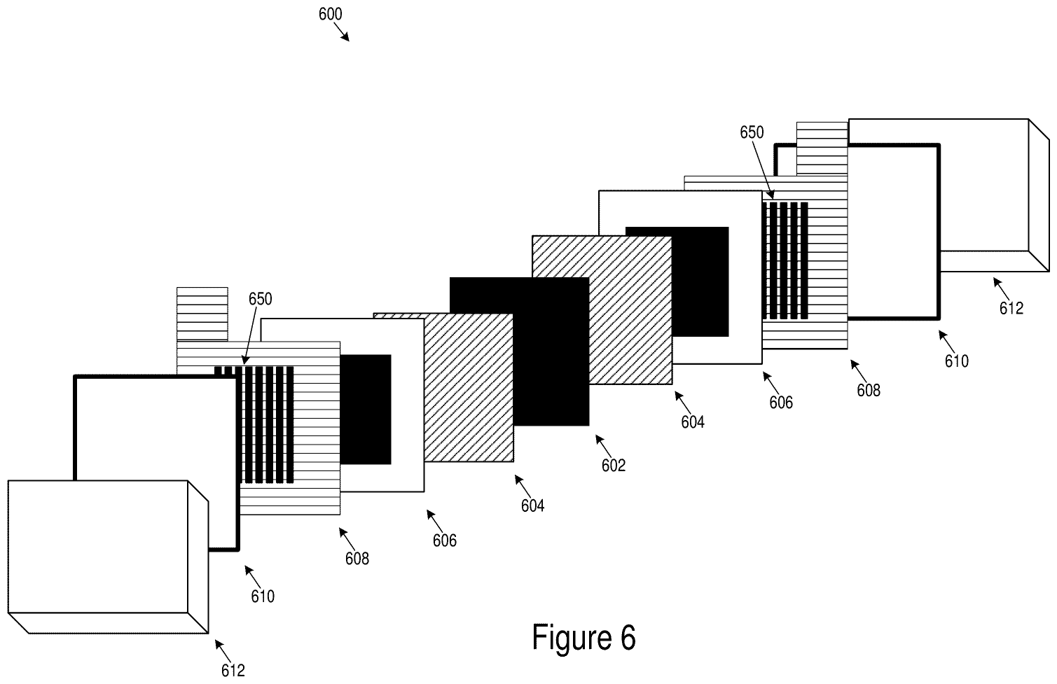

FIG. 6 shows an example electrochemical cell 600. The electrochemical cell includes an electrolysis membrane 602, diffusion layers 604, polymer gaskets 606, 610, flow-field plates 608, and endplates for gas/liquid cycling 612. Conductive adhesive may be applied at example points 650, e.g., the electrode contacts of the flow-field plates 608. In FIG. 6, the various components are sized for clarity of presentation and are not necessarily drawn to scale. Further, the various components of the electrochemical cell 600 are spaced apart for clarity of presentation. Nevertheless, in an assembly, the components of the electrochemical cell 600 are aligned and stacked.

Table 1 includes various examples.

TABLE 1
Examples

| | |
|---|---|
| 1. | A device including: |

```
a membrane;
a flow-field plate;
a diffusion layer between the membrane and the flow-field plate;
an adhesive diffused through the diffusion layer to couple the membrane and the flow-
  field plate;
conductive particles embedded within the adhesive, the conductive particles bringing the
  membrane in electrical contact with the flow-field plate, where:
optionally, the device is in accord with any of the other examples in this table.
```

| | |
|---|---|
| 2. | A device including: |

a membrane;
a flow-field plate;
an adhesive to couple the membrane and the flow-field plate;
conductive particles embedded within the adhesive, the conductive particles bringing the
membrane in electrical contact with the flow-field plate, where:
optionally, the device is in accord with any of the other examples in this table.

| | |
|---|---|
| 3. | A device including: |

```
a pair of flow-field plates;
a membrane between the pair of flow-field plates;
an adhesive to couple each side of the membrane to a respective one of the pair of flow-
  field plates;
conductive particles embedded within the adhesive, the conductive particles bringing
  each side of the membrane in electrical contact with the respective one of the pair of
  flow-field plates, where:
optionally, the device is in accord with any of the other examples in this table.
```

| | |
|---|---|
| 4. | A method including: |

```
applying conductive adhesive to selected portions of an electrochemical cell component;
assembling the electrochemical cell to allow the conductive adhesive to form electrical
  contacts between various components within the electrochemical cell, where:
optionally, assembling the electrochemical cell includes placing a membrane in contact
  with the adhesive to couple the membrane to a flow-field plate and place at least a side
  of the membrane in electrical contact with the flow-field plate, where:
optionally, the method is in accord with any of the other examples in this table.
```

| | |
|---|---|
| 5. | The device or method of any of the other examples in this table, where the |

```
  adhesive diffuses across a diffusion layer between the flow-field plate and the
  membrane.
```

| | |
|---|---|
| 6. | The device or method of any of the other examples in this table, where the flow- |

field plate includes one of a pair of plates coupled to opposite sides of the membrane.

| | |
|---|---|
| 7. | The device or method of any of the other examples in this table, where the |

```
  membrane includes a membrane for proton exchange membrane electrolysis of water
  (PEMWE).
```

| | |
|---|---|
| 8. | The device or method of any of the other examples in this table, further including |

using a mask to apply the adhesive, where:
optionally, the mask directs the adhesive to electrode contact faces on the field-flow

| | |
|---|---|
| | plate. |
| 9. | The device or method of any of the other examples in this table, where the |

```
  conductive particles include platinum particles, gold particles, other noble metal
  particles, other conductive metal particles, graphite particles, and/or other conductive
  material, where:
optionally, the conductive material is stable (over one or more device operation cycles) in
  proton exchange membrane electrolysis of water (PEMWE) conditions.
```

| | |
|---|---|
| 10. | The device or method of any of the other examples in this table, where the |

```
  adhesive includes an epoxy, a butyl rubber compound, a cross-linkable polymer
  compound, or other adhesive, where:
optionally, the adhesive is stable (over one or more device operation cycles) in proton
  exchange membrane electrolysis of water (PEMWE) conditions.
```

| | |
|---|---|
| 11. | The device or method of any of the other examples in this table, where the use of |

```
  conductive adhesive reduces the compressive force used to obtain sufficient electrical
  contact between the flow-field plate and the membrane.
```

| | |
|---|---|
| 12. | The device or method of any of the other examples in this table, where the |

```
  conductive adhesive is used in conjunction with one or more fasteners to fix the
  membrane to the flow-field plate.
```

| | |
|---|---|
| 13. | The device or method of any of the other examples in this table, where the |

conductive adhesive fix the membrane to the flow-field plate, where:
optionally, the membrane is coupled to the flow-field plate via flexible coupling;
optionally, the membrane is coupled to the flow-field plate via semi-rigid coupling;
optionally, the membrane is coupled to the flow-field plate via rigid coupling.

| | |
|---|---|
| 14. | A method including assembling membrane electrodes using a conductive |

adhesive.

| | |
|---|---|
| 15. | A membrane electrode assembly assembled using a conductive adhesive. |

One or more implementations of the disclosure may be referred to herein, individually and/or collectively, by the term “invention” merely for convenience and without intending to voluntarily limit the scope of this application to any particular invention or inventive concept. Moreover, although specific implementations have been illustrated and described herein, it should be appreciated that any subsequent arrangement designed to achieve the same or similar purpose may be substituted for the specific implementations shown. This disclosure is intended to cover any and all subsequent adaptations or variations of various implementations. Combinations of the above implementations, and other implementations not specifically described herein, are apparent to those of skill in the art upon reviewing the description.

As used herein, the singular forms “a,” “an,” and “the” include plural referents unless the context clearly dictates otherwise.

As used herein, “for example,” “for instance,” “such as,” or “including” are meant to introduce examples that further clarify more general subject matter. Unless otherwise expressly indicated, such examples are provided only as an aid for understanding implementations illustrated in the present disclosure and are not meant to be limiting in any fashion. Nor do these phrases indicate any kind of preference for the disclosed implementations.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single implementation for the purpose of streamlining the disclosure. This disclosure is not to be interpreted as reflecting an intention that the claimed implementations require more features than are expressly recited in each claim. Rather, as the following claims reflect, inventive subject matter may be directed to less than all of the features of any of the disclosed implementations. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are within the scope of the disclosure. The claims should not be read as limited to the described order or elements unless stated to that effect. Therefore, all implementations that come within the scope and spirit of the following claims and equivalents thereto are included within the disclosure.

1. An electrochemical cell comprising:
an electrolysis membrane;
a flow-field plate;
a diffusion layer positioned between the electrolysis membrane and the flow-field plate;
an adhesive diffused through the diffusion layer such that the adhesive is in contact with both the electrolysis membrane and the flow-field plate; and
conductive particles embedded within the adhesive, the conductive particles bringing the electrolysis membrane in electrical contact with the flow-field plate.

2. The electrochemical cell of claim 1, where the flow-field plate comprises one plate of a pair of plates coupled to opposite sides of the electrolysis membrane.

3. The electrochemical cell of claim 1, where the electrolysis membrane comprises a proton exchange membrane for electrolysis of water.

4. The electrochemical cell of claim 1, where the conductive particles comprise noble metal particles, graphite particles, or combinations thereof.

5. The electrochemical cell of claim 1, where the adhesive comprises an epoxy, a butyl rubber compound, a cross-linkable polymer compound, or combinations thereof.

6. The electrochemical cell of claim 1, further comprising:
a fastener, wherein the fastener is used in conjunction with the adhesive to affix the electrolysis membrane to the flow-field plate.

7. The electrochemical cell of claim 1, where the adhesive affixes the electrolysis membrane to the flow-field plate.

8. The electrochemical cell of claim 7, where the electrolysis membrane is affixed to the flow-field plate via a flexible coupling.

9. The electrochemical cell of claim 7, where the electrolysis membrane is affixed to the flow-field plate via a rigid coupling.

10. A method comprising:
applying a conductive adhesive to an electrode contact disposed on a flow-field plate of an electrochemical cell;
placing the flow-field plate in contact with a diffusion layer to allow the conductive adhesive to diffuse through the diffusion layer; and
placing an electrolysis membrane in contact with the conductive adhesive diffused through the diffusion layer to electrically couple at least a first side of the electrolysis membrane to the electrode contact disposed on the flow-field plate such that the conductive adhesive is in contact with both the electrolysis membrane and the flow-field plate.

11. The method of claim 10, wherein the applying of the conductive adhesive comprises using a mask to apply the conductive adhesive.

12. The method of claim 11, wherein the using of the mask directs the conductive adhesive to a face of the electrode contact.

13. The method of claim 10, where further comprising:
electrically coupling a second side of the electrolysis membrane to another electrode contact of another flow-field plate.

14. The method of claim 10, wherein the electrolysis membrane comprises a proton exchange membrane for electrolysis of water.

15. The method of claim 10, wherein the conductive adhesive comprises conductive particles including noble metal particles, graphite particles, or combinations thereof.

16. The method of claim 10, wherein the conductive adhesive comprises an epoxy, a butyl rubber compound, a cross-linkable polymer compound, or combinations thereof.

17. The method of claim 10, further comprising:
using a fastener to affix the electrolysis membrane to the flow-field plate.

18. The method of claim 17, further comprising:
adjusting a tightness of the fastener to control a contact level between the electrolysis membrane and the electrode contact via the conductive adhesive.

19. The method of claim 10, wherein the conductive adhesive rigidly affixes the electrolysis membrane to the flow-field plate.

20. An electrochemical cell comprising:
an electrolysis membrane;
a flow-field plate;
an adhesive coupling the electrolysis membrane and the flow-field plate such that the adhesive is in contact with both the electrolysis membrane and the flow-field plate; and
conductive particles embedded within the adhesive, the conductive particles bringing the electrolysis membrane in electrical contact with the flow-field plate.
